(19) United States
(12) Patent Application Publication
(10) Pub. No.: US 2025/0389971 A1
(43) Pub. Date: Dec. 25, 2025

(54) LENTICULAR LENS WITH REDUCED MOIRE IN AN AUTOSTEREOSCOPIC DISPLAY DEVICE

(71) Applicant: Dimenco Holding B.V., Veldhoven (NL)

(72) Inventors: Patrick Godefridus Jacobus Maria Peeters, Veldhoven (NL); Bas Koen Boggemann, Veldhoven (NL)

(21) Appl. No.: 18/877,657

(22) PCT Filed: Jun. 30, 2023
(86) PCT No.: PCT/NL2023/050359

§ 371 Date: Dec. 20, 2024

(30) Foreign Application Priority Data
Jun. 30, 2022 (NL) 2032328

(51) Int. Cl. G02B 30/29; G02B 3/00

(52) U.S. Cl. CPC G02B 30/29; G02B 3/0025

(57) ABSTRACT

The invention relates to a lenticular device comprising a profiled surface which extends in an x-direction and in an y-direction; and has a profiling in a z-direction perpendicular to the profiled surface. The profiled surface defines an array of elongate lenticular elements have lenticular surfaces that intersect with one another along an intersection line. At least one intersection line in the lenticular device is a curved intersection line comprising one or more curved segments that are curved in the x-direction and/or in the z-direction. A lenticular lens with such curved lines reduces moire patterns when positioned on an array of display pixel elements in an autostereoscopic display device. The invention therefore also relates to an autostereoscopic display device comprising such lenticular device and an array of display pixel elements.

### FIELD OF THE INVENTION

The invention relates to a lenticular device, to a method for preparing for such lenticular device, to a lens assembly comprising such lenticular device, to an autostereoscopic display device comprising such lenticular device or such lens assembly, and to a method for reducing moire patterns in an autostereoscopic display device.

### BACKGROUND

Autostereoscopic displays are playing an increasingly important role in virtual reality and augmented reality applications. One of their most outstanding features is that they allow a viewer to perceive depth in the images they display (stereoscopy), without the need for glasses or other dedicated eyewear. Moreover, this principle even works when the viewer moves relative to the autostereoscopic display.

Key to this technology is the presence of a screen that comprises a lenticular lens or a parallax barrier placed in front of an array of pixels. This enables that pixel output (i.e. light) can be directed to particular spatial directions, which allows selective illumination of only one eye of a pair of eyes. By accurately controlling the pixels, the screen can direct simultaneously a left eye image to a left eye of the viewer and a right eye image to a right eye of the viewer. The resulting stereoscopic image may provide a depth perception to the viewer, wherein elements in the image may appear in front of the display or further away than the display (‘behind’ the display).

Many conventional autostereoscopic displays however have the problem that they exhibit moire patterns. A lenticular lens and a parallax barrier are both regular structures composed of semi-cylindrical micro-lenses (lenticulars) or elongate slits, respectively, that are arranged parallel to one another. The superposition of such a regular structure and the (also regular) array of pixels may cause a viewer to perceive moire patterns, which are often disturbing to the viewer. Not only because they spoil displayed images, but also because moire patterns make the screen itself visible, as for instance reflections also do. This brakes the illusion of a “free floating” three-dimensional image in the environment before or behind the screen.

To date, many efforts have been deployed to reduce or even completely cancel moire patterns in this type of displays. For example, it is possible to identify the pixels that make the largest contribution to the moire and to then modify their pixel output in a specific way. This however has undesired side-effects such as a reduced resolution and/or a reduced display intensity. It also requires valuable processor capacity. Other solutions concern the application of specific pixel shapes and pixel arrangements in combination with specific lenticular slant angles. This however limits the design opportunities of the autostereoscopic display device and it makes fabrication processes more critical, as slant deviations as small as a fraction of a degree can already cause moire.

### SUMMARY OF THE INVENTION

It is therefore an object of the present invention to find a solution to the appearance of moire patterns that does not exhibit one or more of the abovementioned side-effects. It is also an object to provide a solution that is less complicated than solutions known in the art. It is more generally an object of the present invention to improve the viewing experience of a viewer of an autostereoscopic display.

It has now been found that one or more of these objects can be reached by applying a certain modification to the lenticular lens of an autostereoscopic display.

Accordingly, the present invention relates to a lenticular device (1) having a profiled surface (2) which
extends in an x-direction and in an y-direction perpendicular to the x-direction; and
has a profiling in a z-direction perpendicular to the profiled surface (2); the profiled surface (2) defining an array of elongate lenticular elements (3) which
have a lenticular length in the y-direction;
are arranged parallel to one another;
have lenticular surfaces that intersect with one another along an intersection line (4);
   wherein at least one intersection line (4) is a curved intersection line.

The lenticular device (1) may be a lenticular lens or a mold for preparing a lenticular lens.

The present invention further relates to an autostereoscopic display device comprising an array (9) of display pixel elements and a lenticular lens as described above.

The present invention further relates to a method for manufacturing a lenticular device having a profiled surface defining an array of elongate lenticular elements, the method comprising
providing a plate with an engravable surface which
   extends in an x-direction and in an y-direction perpendicular to the x-direction; and
   has a z-direction perpendicular to the engravable surface;
providing an apparatus comprising a chisel having a shape that corresponds in negative relief to a shape of a cross-section of an elongate lenticular element in the lenticular device that is manufactured with the method;
sequentially engraving a plurality of parallel elongate lenticular elements in the plate with the chisel by moving the chisel in the y-direction of the plate to form the profiled surface, wherein the lenticular elements that are formed in the plate intersect with one another at an intersection line;
   wherein, during the moving of the chisel in the z-direction, the chisel is moved in the x-direction and/or in the z-direction in such way that a curved intersection line is formed.

The present invention further relates to a method for manufacturing an autostereoscopic display device, comprising the use of a lenticular lens as described hereabove or the use of a lens assembly comprising an array of display pixel elements and a lenticular lens as described hereabove.

The present invention further relates to a method for reducing moire patterns in an autostereoscopic display device, comprising the use of a lenticular lens as described above, in particular by lining an array of display pixel elements with a lenticular lens as described above.

### BRIEF DESCRIPTION OF THE DRAWINGS

FIG. 1 schematically displays a first lenticular device according to the invention.

FIG. 2 schematically displays a second lenticular device according to the invention.

FIG. 3 schematically displays a third lenticular device according to the invention.

FIG. 4 schematically displays a fourth lenticular device according to the invention.

FIG. 5 schematically displays a fifth lenticular device according to the invention.

FIG. 6 schematically displays a sixth lenticular device according to the invention.

FIG. 7 schematically displays a seventh lenticular device according to the invention.

FIG. 8 schematically displays a lens assembly according to the invention.

### DETAILED DESCRIPTION OF THE INVENTION

The figures do not limit the present invention to the specific embodiments disclosed therein and described in the present description. Elements in the figures are illustrated for simplicity and clarity and have not necessarily been drawn to scale, emphasis instead being placed upon clearly illustrating the principles of the invention. For example, the dimensions of lenticular elements and the extent of curvature of the intersection lines between them cannot be derived from the figures. The shape and arrangement of display pixel elements in the figures is not intended to be a reflection of reality. Further, their dimensions relative to the dimensions of lenticular elements can neither be derived from the figures.

Further, the terms “first”, “second”, and the like in the present description and claims, if any, are generally used for distinguishing between similar elements or items and not necessarily for describing a sequential or chronological order.

In the context of the invention, by the term ‘viewer’ is meant a person who can consume, in particular view, content presented by an autostereoscopic display device. Throughout the text, references to the viewer will be made by male words like ‘he’, ‘him’ or ‘his’. This is only for the purpose of clarity and conciseness, and it is understood that female words like ‘she’, and ‘her’ equally apply.

In the context of the invention, by the term ‘moire’ is meant a viewer's perception of a pattern (a ‘moire pattern’) that emerges by the superimposition of two real patterns that are slightly displaced, slightly rotated, and/or have a slightly different pitch. Also when the pitch of one pattern is nearly (but not exactly) an integer (2, 3, 4, etc.) multiplex of the pitch of the other pattern, moire may occur. Moire that is reduced or overcome in the present invention typically concerns the superimposition of the pattern of the pixel array and the pattern of the lenticular array.

Some terms introduced herebelow, such as ‘lenticular length’, ‘V-shaped valley’, ‘sharp ridge’, and ‘intersection line,’ are presented as extending in the ‘y-direction’. It is understood, however, that in certain embodiments of the present invention, these terms also have a component in the x-direction and/or in the z-direction (albeit very small component), viz. in embodiments wherein a curved intersection line comprises one or more curved segments that are curved in the x-direction and/or in the z-direction. For the sake of clarity, however, this is not constantly mentioned. After all, when averaged over the entire lenticular device, the terms concerned are extending in only the y-direction of the lenticular device of the invention.

A lenticular device according to the invention is an object that comprises a profiled surface, i.e. a surface with a surface relief or profiling.

For the purpose of clearly describing the invention, an x-direction, an y-direction and a z-direction are defined for a lenticular device according to the invention. Herein, the y-direction is perpendicular to the x-direction and the z-direction is perpendicular to a plane defined by the x-direction and the y-direction (an (x,y)-plane). The surface of the lenticular device extends in the x-direction and in the y-direction, irrespective of the surface relief that extends in the z-direction.

The profiled surface is shaped as an array of lenticular elements that have an elongate shape (and an elongation) in the y-direction, defining a lenticular length in the y-direction. The lenticular elements are arranged side-by-side in the x-direction and extend in the y-direction parallel to one another. When lined on an array of display pixel elements, such an array of lenticular elements is a known means to direct the outputs from different pixel elements in mutually different directions so as to enable that a stereoscopic image is displayed to a viewer (being perceived as three-dimensional by a viewer).

Herein, the term ‘arranged’ is merely used to describe a certain look or appearance rather than a composition of separate parts, since the lenticular elements are not arranged as separate objects. The lenticular device according to the invention in principle consists of one single part, so that the different lenticular elements are all part of the same piece of material. Optionally, the lenticular lens is provided with a coating and/or a casing. The lenticular elements in a lenticular device of the invention have either a convex (round) shape or a concave (hollow) shape, meaning that a lenticular device typically comprises only one of these types of lenticular elements.

The side-by-side arrangement is meant to be understood as an arrangement wherein neighboring lenticular elements ‘touch’ one another in the sense that there is in principle no interbedded surface between two neighboring lenticular elements that is not of a lenticular shape, such as a flat surface that extends in the x-direction and the y-direction (when the lenticular device would have been prepared by engraving the lenticular elements in a flat surface of a plate, a flat interbedded surface between two neighboring lenticular elements would correspond to surface that had not been treated by the engraving).

The boundary between two neighboring lenticular elements is indicated by an abrupt change of the slope of the profiled surface in a cross-sectional plane defined by the x-direction and the z-direction (i.e. the (x,z)-plane). In case the lenticular elements have a convex shape, the boundary between two lenticular elements can be regarded as a V-shaped valley that extends in the y-direction of the profiled surface; and in case the lenticular elements have a concave shape, the boundary between two lenticular elements can be regarded as a sharp ridge that extends in the y-direction on the profiled surface.

The boundary between two neighboring lenticular elements is formed by a line coinciding with either the lowest points in the V-shaped valley (i.e. lowest in the z-direction); or with the highest points of the sharp ridge (i.e. highest in the z-direction). This line is in fact an intersection of the lenticular surfaces of two neighboring lenticular elements. For the purpose of the invention, this line is therefore indicated by the term ‘intersection line’.

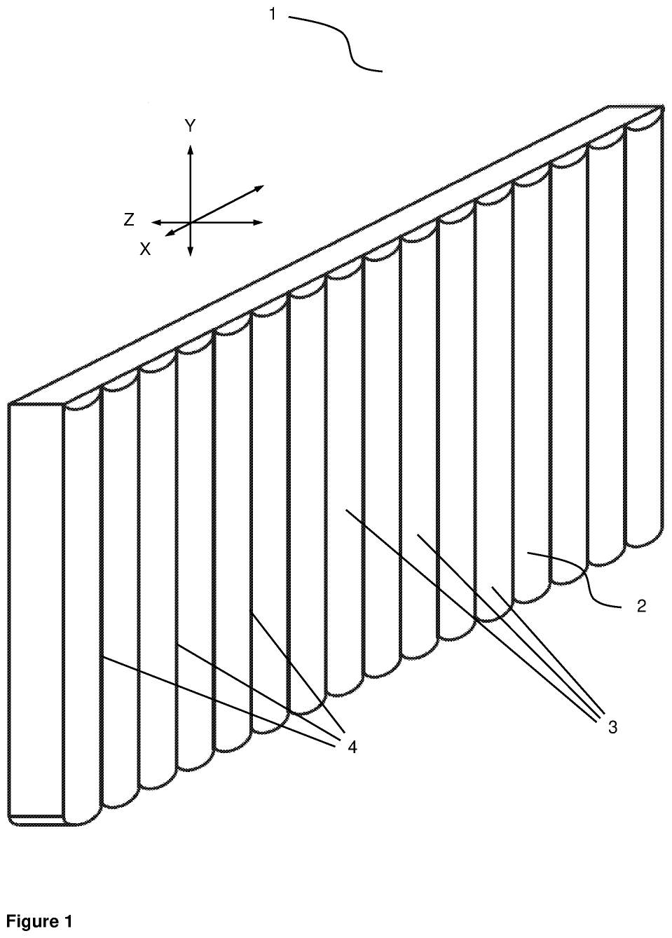

FIG. 1 schematically displays a lenticular device (1) according to the invention. It comprises a profiled surface (2) that defines an array of elongate lenticular elements (3). Each of these has a lenticular surface that intersects with the lenticular surface of a neighboring lenticular element (3) along an intersection line (4). For reasons of clarity, FIG. 1 does not express that one or more intersection lines (4) are curved, as is required by the invention. Curved intersection lines (4) are however clearly illustrated by the remaining FIGS. 2-8.

Besides the lenticular length, the lenticular elements also have a lenticular width. This dimension is defined as the distance between two intersection lines on either side of a lenticular element, somewhere along the y-direction, measured in the x-direction. The distance is however not measured via a line that directly connects both intersection lines, but via a line that is projected on both intersection lines from the z-direction. This is to accommodate for deviations that occur in the event that a line that directly connects both intersection lines has a component in the z-direction (as may be the case with a lenticular lens according to the invention, which is further elaborated below).

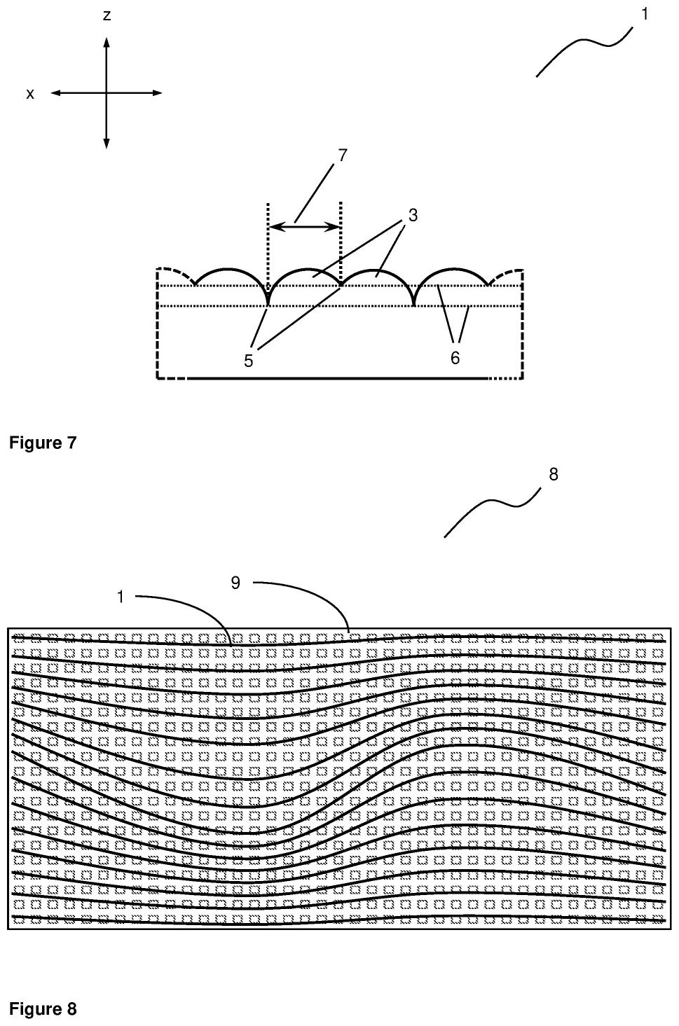

The definition of lenticular width (7) is illustrated in FIG. 7, which displays a cross-sectional view of a lenticular device (1) of the invention in the (x,z)-plane. On either side of a lenticular element (3), a valley (5) is present which defines an intersection line that runs perpendicular to the plane of the drawing (therefore not shown). The valleys (5) on either side of a lenticular element (3) have a different position in the z-direction, which difference is indicated by the two horizontal dotted lines (6). The distance between both valleys, projected in the z-direction, forms the lenticular width (7).

Further, it may be stated throughout the text that elongate items that are not perfectly straight, are arranged parallel to one another. By the term ‘parallel’ is then meant, that the items are arranged side-by-side, facing one another with their longest dimensions. In this way, their arrangement is regarded parallel.

The lenticular elements in prior art lenticular devices are all straight and have identical shapes. This is however not the case in a lenticular device of the invention, where the lenticular elements are curved in the x-direction and/or in the z-direction. A particular curvature may apply to all lenticular elements (so that they are still identical); or different lenticular elements may be subject to different curvatures (so that not all lenticular elements are identical).

When a lenticular element is curved, one or both of the two intersection lines on either side of the lenticular element have a curvature. Accordingly, the invention is characterized in that the lenticular lens comprises at least one intersection line that is a curved intersection line. The curvature may be in the x-direction and/or in the z-direction.

A curved intersection line is a line that has at least one segment that is curved. By the term ‘curved’ is meant that the line is not straight, but that it is bent. Such a bending is usually a smooth change of the direction of the line. It may however also be an abrupt change, for example a corner or a zigzag.

A curved intersection line may be curved along its entire length, or along a part of its entire length. In the latter case, the intersection line for example comprises one or more curved segments and one or more straight segments.

In the context of the invention, a segment of an intersection line may comprise a certain part of the intersection line or the entire intersection line. Further, a curved segment of an intersection line may be any segment that does not contain a straight part. Curved segments may be neighboring other curved segments without a straight segment in between the curved segments.

Typically, a curved intersection line is a line that comprises one or more curved segments that are curved. For example, one or more curved segments are curved in the x-direction, one or more curved segments are curved in the z-direction, or one or more curved segments are curved in the x-direction as well as in the z-direction. There may also be segments wherein different curvatures are present in a single lenticular element, for example at least one segment that is curved in the x-direction and at least one segment that is curved in the z-direction.

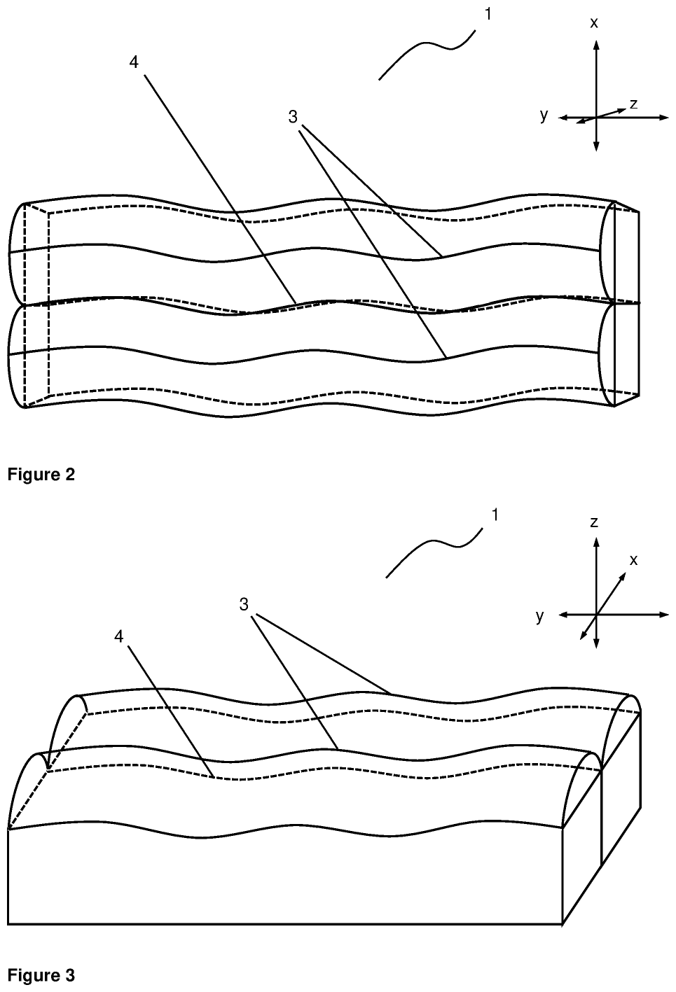

FIG. 2 and FIG. 3 are perspective views of a first and a second lenticular device (1) according to the invention. They display two neighboring lenticular elements (3) that share an intersection line (4). In FIG. 2, the intersection lines (4) have a curvature only in the x-direction. In FIG. 3, the intersection lines (4) have a curvature only in the z-direction.

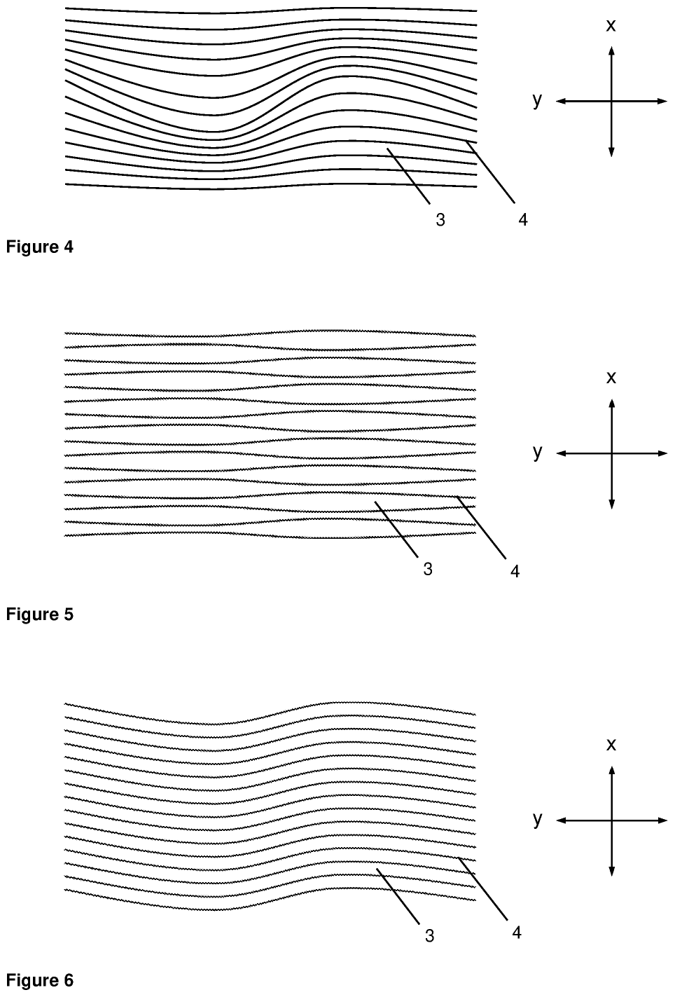

FIGS. 4-6 are schematical top views of three different embodiments according to the invention. They display lenticular elements (3) and curved intersection lines (4), wherein the curved intersection lines (4) are curved in the x-direction. In these figures, emphasis is placed on the different shapes and relative arrangements of the intersection lines (4).

In FIG. 4, the curved intersection lines (4) are different in that they have different curvatures. The lenticular elements (3) in the middle part of the lenticular device (1) have a larger displacement in the x-direction that those above and below. The displacement of lenticular elements (3) in the middle part (having the largest displacements) exceed the largest lenticular widths multiple times.

In FIG. 5, the curved intersection lines (4) all have the same curvature but have a different ‘phase’, so that lenticular elements (3) have a variation in their lenticular width along the y-direction.

In FIG. 6, the curved intersection lines (4) are all the same and have the same ‘phase’, so that lenticular elements (3) have a constant lenticular width along the y-direction.

For the purpose of the invention, the extent of curvature of an intersection line in the x-direction is described by the variation of the intersection line in the x-direction, which is a distance range in the x-direction between which the intersection line has curvatures. These variations are defined by relating them to the average lenticular width. To this end, the average lenticular width is multiplied by a factor that lies in a particular range. In a lenticular device of the invention, a curved intersection line may exhibit a variation in the x-direction that is up to 1.0 times the average lenticular width, wherein the average lenticular width is defined as the length of the array in the x-direction divided by the number of lenticular elements that is present in the x-direction.

The variation in the x-direction may also be larger than 1.0 times the average lenticular width, it may for example be up to 2.0 times, up to 5.0 times or up to 10 times the average lenticular width (see e.g. FIG. 4). Such large variations require that neighboring intersection lines are subject to similar variations in the x-direction. Otherwise, the lenticular elements become either too small or they are so far apart that an intersection line cannot be defined. This is explained in the below paragraph.

A variation of an intersection line in the x-direction is usually only allowable when the separation of two intersection lines on either side of a lenticular element is not reduced too much, because this would make the lenticular element too narrow so that the field of view of the lenticular element would become too small for providing a good viewing experience. Therefore, a separation of 0.60 times the average lenticular width is usually taken as a minimum. There is also an upper limit to the separation of two intersection lines, because it cannot go beyond the span in the x-direction that can be reached by a lenticular element with a given shape. A value of 1.40 times the average lenticular width is usually taken as a maximum.

Accordingly, in a lenticular device according to the invention, two neighboring intersection lines are usually separated by a varying distance that is in the range of 0.60-1.40 times the average lenticular width, measured along the x-direction, wherein the average lenticular width is defined as the length of the array in the x-direction divided by the number of lenticular elements that is present in the x-direction.

The varying distance between two intersection lines may also vary in the range of 0.65-1.35, in the range of 0.70-1.30, in the range of 0.75-1.25, in the range of 0.80-1.20, in the range of 0.85-1.15, in the range of 0.90-1.10, in the range of 0.93-1.07, or in the range of 0.95-1.05 times the average lenticular width.

For the purpose of the invention, the extent of curvature of an intersection line in the z-direction is described by the variation of the intersection line in the z-direction, which is a distance range in the z-direction between which the intersection line has its curvatures. These values are also defined by relating them to the average lenticular width. To this end, the average lenticular width is multiplied by a factor that lies in a particular range. In a lenticular device of the invention, a curved intersection line may exhibit a variation in the z-direction that is up to 1.0 times the average lenticular width, wherein the average lenticular width is defined as the length of the array in the x-direction divided by the number of lenticular elements that is present in the x-direction.

The variation in the z-direction may also be larger than 1.0 time the average lenticular width, it may for example be up to 2.0 times, up to 3.0 times or up to 5 times the average lenticular width. Such large variations require that neighboring intersection lines are subject to similar variations in the z-direction. Otherwise, one lenticular element may become too much elevated above another, neighboring, lenticular element.

Some or all of the curved intersection lines may also have essentially the same shape. When two of such intersection lines are on either side of a lenticular element, then the lenticular element may have a constant lenticular width (see e.g. FIG. 6).

Accordingly, in a lenticular device of the invention, there may be at least one lenticular element that has a lenticular width that is substantially constant over its lenticular length. The number of such lenticular elements is usually however higher. It is preferably defined as a percentage of the total number of lenticular elements that are part of the lenticular device of the invention. For example, the percentage of such lenticular elements is at least 10%, at least 25%, at least 50%, at least 75%, at least 90% or at least 95%,

Generally, in a lenticular device according to the invention, at least 50% of the intersection lines is a curved intersection line. The percentage may also be at least 10%, at least 20%, at least 30%, at least 40%, at least 60%, at least 70%, at least 80%, at least 90% or at least 95%. It is also possible that all intersection lines are curved intersection lines.

In a lenticular device according to the invention, a plurality of (x,z)-planes may be defined perpendicular to the lenticular length of the lenticular elements. A cross-sectional shape of the lenticular elements in each of the (x,z)-planes may then have an aspect ratio x:z that is in the range of 6:1 to 3:1, in particular in the range of 5:1 to 4:1.

Lenticular elements in prior art lenticular lenses have a focal distance that allows them to focus light along a focal line that runs parallel to the lenticular length (i.e. in the y-direction). Such focal line is an aggregation of focal points that together form the focal line.

The same accounts for a lenticular device of the invention when the lenticular device is a lenticular lens. In such case, it is made of a transparent material that allows it to function as a lenticular lens.

A lenticular device of the invention is however not necessarily a lenticular lens. It may also be of a non-transparent material. In this way, it may for example act as a lenticular mold for the production of a lenticular lens, for example by contacting the profiled surface with a (usually fluid) curable resin followed by curing the curable resin to yield a solid and transparent lens material. Despite the fact that such lenticular molds are usually not capable to act as a lens (because they are of a non-transparent material), they still fall within the scope of the present invention since they have the same lenticular surface as true lenticular lenses (only corresponding in negative relief thereto). Such lenticular device of the invention may in principle be made from any material that is suitable to act as a mold in a molding process.

Accordingly, in an embodiment, a lenticular device of the invention is a lenticular lens, e.g. a device that is capable of refracting light when the light passes through the lens. In another embodiment, a lenticular device of the invention is a mold for preparing a lenticular lens.

Thus, the lenticular elements of a device of the invention may in some instances not function as a lenticular lens, yet indeed have the same profiling as a true lenticular lens, viz. in case the device is of a non-transparent material. In such case, the shape of the lenticular elements can be equated with the shape of a true lenticular lens.

Therefore, in particular in case the lenticular device of the invention is of a non-transparent material, then the lenticular elements of such lenticular device may be considered to have a cross-sectional shape in an (x,z)-plane that corresponds to the cross-sectional shape of a lenticular lens with a particular focal distance, rather than that they are a lens with such focal distance (thus, if the mold would be made of a lens material, then its lenticular elements would have a particular focal distance).

In a particular embodiment, the lenticular elements may be considered to have a cross-sectional shape in any (x,z)-plane that corresponds to the cross-sectional shape of a lenticular lens with a constant focal distance in the (x,z)-plane. This means that, in case the lenticular device of the invention is a lenticular lens, the focal distance of the lenticular elements is constant over the entire length of each lenticular element (i.e. in the y-direction); and that, in case the lenticular device of the invention is a lenticular mold, the focal distance of the lenticular elements of a lenticular lens that is prepared from the mold is constant over the entire length of each lenticular element. It is herewith understood that in case the lenticular lens would be a concave lenticular lens, the focal point would have to be identified as the virtual focal point. Correspondingly, such lenticular lens would have a constant virtual focal point over the entire length of each lenticular element.

It is understood that lenticular elements may have shapes that only by approximation give rise to an exact focal point, for example because their convex or concave shape is not of a perfect parabolic shape. For example, a circular shape may be a good approximation, especially when only a relatively small angle of the circle is used. Lenticular devices with any such lenticular elements (e.g. non-parabolically shaped) that are capable of providing a useful imaging when applied in an autostereoscopic display device are included in the present invention.

The invention further relates to a lens assembly (8) comprising an array (9) of display pixel elements and a lenticular device (1) as described above, wherein the lenticular device (1) is a lenticular lens. The array is typically lined with the lenticular lens, so that the lenticular lens covers at least a part of the array.

Such lens assembly is schematically displayed in FIG. 8. Due to the curves of the intersection lines, the regular ordering of lenticular elements is ‘broken’. As a result, the display pixel elements find no ordered counterpart in the lenticular elements that may give rise to moire patterns. As a result, an autostereoscopic display device comprising a lens assembly of the invention exhibits less moire than known autostereoscopic display devices.

The invention further relates to an autostereoscopic display device comprising a lens assembly as described hereabove.

The invention further relates to an autostereoscopic display device comprising an array (9) of display pixel elements and a lenticular device (1) as described above, wherein the lenticular device (1) is a lenticular lens. The array is typically lined with the lenticular lens, so that the lenticular lens covers at least a part of the array.

The invention further relates to a method for manufacturing a lenticular device having a profiled surface defining an array of elongate lenticular elements, the method comprising
providing a plate with an engravable surface which
   extends in an x-direction and in an y-direction perpendicular to the x-direction; and
   has a z-direction perpendicular to the engravable surface;
providing an apparatus comprising a chisel having a shape that corresponds in negative relief to a shape of a cross-section of an elongate lenticular element in the lenticular device that is manufactured with the method;
subsequently engraving a plurality of parallel elongate lenticular elements in the plate with the chisel by moving the chisel in the y-direction of the plate to form the profiled surface, wherein the lenticular elements that are formed in the plate intersect with one another at an intersection line;
   wherein, during the moving of the chisel in the z-direction, the chisel is moved in the x-direction and/or in the z-direction in such way that a curved intersection line is formed.

In this method, single lenticular elements (or groups of a few lenticular elements, for example 2, 3 or 4) are produced by the sequential engraving of them. In this way, each lenticular element can be prepared in a manner that is different from a neighboring lenticular element. This may yield any lenticular device as described hereabove.

When it is desired that the curved intersection line of a lenticular device of the invention comprises one or more curved segments that are curved only in the z-direction (and not in the x-direction), then the two lenticular elements that share such an intersection line need to be engraved by moving the chisel in exactly the same way for each lenticular element, i.e. without any lateral movement in the x-direction and with the same movement in the z-direction (see e.g. FIG. 3). After all, when two neighboring lenticular elements would be engraved at a different depth in the surface, then this gives rise to an intersection line between both lenticular elements that exhibits a variation in the x-direction.

When the curved intersection line of a lenticular device of the invention comprises one or more curved segments that are curved only in the x-direction (and not in the z-direction), then the two lenticular elements that share such an intersection line are engraved by moving the chisel in exactly the same way for each lenticular element, i.e. without any movement in the z-direction and with the same lateral movement in the x-direction (see e.g. FIG. 2). After all, when two neighboring lenticular elements would be engraved with a different lateral movement, then this gives rise to an intersection line between both lenticular elements that exhibits a variation in the z-direction.

A method of the invention is optionally followed by a molding step, wherein the profiled surface is contacted with a fluid curable resin, followed by curing the curable resin to yield a lenticular lens. Alternatively, in the molding step, the profiled surface is contacted with a fluid or moldable (e.g. thermoplastic) material at an elevated temperature, followed by cooling down the material to yield a lenticular lens.

In an embodiment, the method of the invention is followed by manufacturing an autostereoscopic display device by using the manufactured lenticular device, wherein the lenticular device is a lenticular lens.

In an embodiment, the method of the invention is followed by preparing a lens assembly comprising an array of display pixel elements and a lenticular device as described hereabove, wherein the lenticular device is a lenticular lens.

This typically comprises lining the array with the lenticular lens, so that the lenticular lens covers at least a part of the array.

Optionally, the method for preparing a lenticular lens assembly is followed by manufacturing an autostereoscopic display device by using the prepared lenticular lens assembly.

The invention further relates to a method for reducing moire patterns in an autostereoscopic display device, comprising the use of a lenticular lens as described above. The method may in particular comprise lining an array of display pixel elements with a lenticular lens as described above.

1. A lenticular device, comprising:
a screen having a profiled surface,
the profiled surface extending in an x-direction and in a y-direction perpendicular to the x-direction,
the profiled surface having a profiling in a z-direction perpendicular to the profiled surface,
the profiled surface defining an array of elongate lenticular elements,
the elongate lenticular elements of the array of elongate lenticular elements having a lenticular length in the y-direction,
the elongate lenticular elements of the array of elongate lenticular elements being arranged parallel to one another,
the elongate lenticular elements of the array of elongate lenticular elements having lenticular surfaces that intersect with one another along a corresponding intersection line,
at least one intersection line being a curved intersection line.

2. The lenticular device of claim 1, wherein the curved intersection line comprises one or more curved segments that are curved in the x-direction.

3. The lenticular device of claim 1, wherein the curved intersection line comprises one or more curved segments that are curved in the z-direction.

4. The lenticular device of claim 1, wherein the curved intersection line comprises one or more curved segments that are curved in the x-direction and the z-direction.

5. The lenticular device of claim 1, wherein the curved intersection line comprises one or more curved segments that are curved in the x-direction, the one or more curved segments each having a variation in the x-direction that is up to 1.0 times an average lenticular width, the average lenticular width being defined as a length of the array of elongate lenticular elements in the x-direction divided by a number of lenticular elements in the array of elongate lenticular elements that are present in the x-direction.

6. The lenticular device of claim 1, wherein the curved intersection line comprises one or more curved segments that are curved in the z-direction, the one or more curved segments each having a variation in the z-direction that is up to 1.0 times an average lenticular width, the average lenticular width being defined as a length of the array of elongate lenticular elements in the x-direction divided by a number of lenticular elements in the array of elongate lenticular elements that are present in the x-direction.

7. The lenticular device of claim 1, wherein two neighboring intersection lines are separated by a varying distance that is between 0.60 times an average lenticular width and 1.40 times the average lenticular width, inclusive, measured along the x-direction, wherein the average lenticular width is defined as a length of the array of elongate lenticular elements in the x-direction divided by a number of lenticular elements in the array of elongate lenticular elements that are present in the x-direction.

8. The lenticular device of claim 1, wherein the array of elongate lenticular elements includes at least one lenticular element having a lenticular width that is substantially constant over its lenticular length, the lenticular width being defined as a projected distance in the x-direction between two intersection lines on either side of a lenticular element, the projected distance being projected in the z-direction.

9. The lenticular device of claim 1, wherein;
a plurality of (x,z)-planes are defined perpendicular to the lenticular length of the elongate lenticular elements of the array of elongate lenticular elements; and
a cross-sectional shape of the elongate lenticular elements of the array of elongate lenticular elements in each (x.z) plane of the plurality of (x,z)-planes has an aspect ratio x:z that is between 6:1 and 3:1, inclusive.

10. The lenticular device of claim 1, wherein;
a plurality of (x,z)-planes are defined perpendicular to the lenticular length of the elongate lenticular elements of the array of elongate lenticular elements; and
a cross-sectional shape of the lenticular elements in the (x,z)-planes corresponds to a cross-sectional shape of a lenticular lens with a focal distance that is constant along the lenticular length.

11. The lenticular device of claim 1, wherein at least 50% of the intersection lines are curved intersection lines, in particular at least 80%.

12. The lenticular device of claim 1, wherein the screen includes a lenticular lens or a mold for preparing a lenticular lens

13. The lenticular device of claim 1, wherein the screen includes a mold for preparing a lenticular lens.

14. The lenticular device of claim 12, wherein the screen includes a lenticular lens, the lenticular device further comprising an array of display pixel elements, the lenticular lens and the array of display pixel elements forming a lens assembly suitable for use in an autostereoscopic display device

15. (canceled)

16. A method for manufacturing a lenticular device having a profiled surface defining an array of elongate lenticular elements, the method comprising:
providing a plate with an engravable surface, the engravable surface extending in an x-direction and in a y-direction perpendicular to the x-direction, the engravable surface having a z-direction perpendicular to the engravable surface;
providing an apparatus comprising a chisel having a shape that corresponds in negative relief to a shape of a cross-section of an elongate lenticular element in the lenticular device; and
engraving a plurality of parallel elongate lenticular elements in the plate with the chisel by moving the chisel in the y-direction, and at least one of the x-direction or the z-direction, of the plate to form the profiled surface, the elongate lenticular elements of the array of elongate lenticular elements that are formed in the plate intersecting with one another at a curved intersection line.

17-20. (canceled)

21. The lenticular device of claim 1, wherein two neighboring intersection lines are separated by a varying distance that is between 0.80 times an average lenticular width and 1.20 times the average lenticular width, inclusive, measured along the x-direction, wherein the average lenticular width is defined as a length of the array of elongate lenticular elements in the x-direction divided by a number of elongate lenticular elements in the array of elongate lenticular elements that are present in the x-direction.

22. The lenticular device of claim 1, wherein:
a plurality of (x,z)-planes are defined perpendicular to the lenticular length of the elongate lenticular elements in the array of elongate lenticular elements; and
a cross-sectional shape of the elongate lenticular elements in the array of elongate lenticular elements in each (x,z)-plane of the plurality of (x,z)-planes has an aspect ratio x:z that is between 5:1 and 4:1, inclusive.

23. The lenticular device of claim 1, wherein at least 80% of the intersection lines are curved intersection lines.
